(19) United States
(12) Patent Application Publication
(10) Pub. No.: US 2007/0291852 A1
(43) Pub. Date: Dec. 20, 2007

(54) Moving picture reproducing apparatus

(75) Inventor: Hirofumi Mori, Koganei-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/633,389

(22) Filed: Dec. 1, 2006

(30) Foreign Application Priority Data
Jun. 15, 2006 (JP) 2006-166045

(51) Int. Cl. H04B 1/66

(52) U.S. Cl. 375/240.27

(57) ABSTRACT

If a frame which should be referred to does not drop, a reference picture list forming unit forms a reference picture list on the basis of the number of reference frames and the serial numbers of the decoded pictures stored in the decoded picture buffer. On the other hand, if the frame which should be referred to drops, the reference picture list correcting unit forms a reference picture list including an instruction to refer to a frame immediately before the dropout frame, instead of the dropout frame. A decoder reads from the decoded picture buffer the decoded pictures based on the reference picture list formed by the reference picture list forming unit or the reference picture list correcting unit, and obtains the decoded pictures by decoding the stream data on the basis of the read decoded pictures.

### CROSS-REFERENCE TO RELATED APPLICATIONS

This application is based upon and claims the benefit of priority from prior Japanese Patent Application No. 2006-166045, filed Jun. 15, 2006, the entire contents of which are incorporated herein by reference.

### BACKGROUND OF THE INVENTION

1. Field of the Invention

The present invention relates to a moving picture reproducing apparatus employing a compression scheme of implementing a high encoding rate by using a plurality of reference frames.

2. Description of the Related Art

A conventional moving picture reproducing apparatus has implemented a high encoding rate by using a plurality of reference frames, such as a moving picture compression scheme of ITU-T (International Telecommunication Union—Telecommunication Sector) Recommendation H.264.

However, if such a moving picture compression scheme is employed when a transmission path is in an environment in which errors may occur, the number of reference frames on the encoder often does not match that on the decoder due to influences such as packet loss. When reference frames are dropped on the decoder under this condition, decoding cannot be normally executed.

In the conventional moving picture reproducing apparatus, when a transmission path is in an environment in which errors may occur, the number of reference frames on the encoder often does not match that on the decoder due to influences such as packet loss. When reference frames are dropped on the decoder under this condition, reference frames which cannot be used for reference are generated and decoding cannot be executed.

### BRIEF SUMMARY OF THE INVENTION

The present invention has been accomplished to solve the above-described problems. The object of the present invention is to provide a moving picture reproducing apparatus capable of, even if the number of reference frames on the encoder side does not match that on the decoder due to influences such as the packet loss, etc., executing the decoding and reducing the influences to the reproduced pictures to a minimum.

To achieve this object, an aspect of the present invention is a moving picture reproducing apparatus, decoding stream data including picture data in which a moving picture is encoded for each frame. The apparatus comprises memory means for storing the decoded picture data, decoding means for referring to picture data represented by a reference list, of the picture data stored by the memory means, and decoding the picture data included in the stream data, reference frame number detecting means for detecting number of reference frames corresponding to the picture data from the stream data, dropout detecting means for detecting lost the picture data from the stream data, and reference list forming means for forming the reference list in accordance with the number of reference frames detected by the reference frame number detecting means. If the dropout detecting means detects the lost picture data, the reference list forming means forms the reference list indicating referring to picture data decoded prior to the lost picture data, instead of the lost picture data.

This aspect of the present invention can provide a moving picture reproducing apparatus capable of, even if the number of reference frames on the encoder does not match that on the decoder due to influences such as the packet loss, etc., executing the decoding and reducing the influences to the reproduced pictures to a minimum.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a moving picture reproducing apparatus according to an embodiment of the present invention;

FIG. 2 is a flowchart showing decoding of the moving picture reproducing apparatus shown in FIG. 1;

FIG. 3 is an illustration showing a process of forming a reference picture list in the processing shown in FIG. 2 when frame loss does not occur; and

FIG. 4 is an illustration showing a process of forming a reference picture list in the processing shown in FIG. 2 when frame loss occurs.

### DETAILED DESCRIPTION OF THE INVENTION

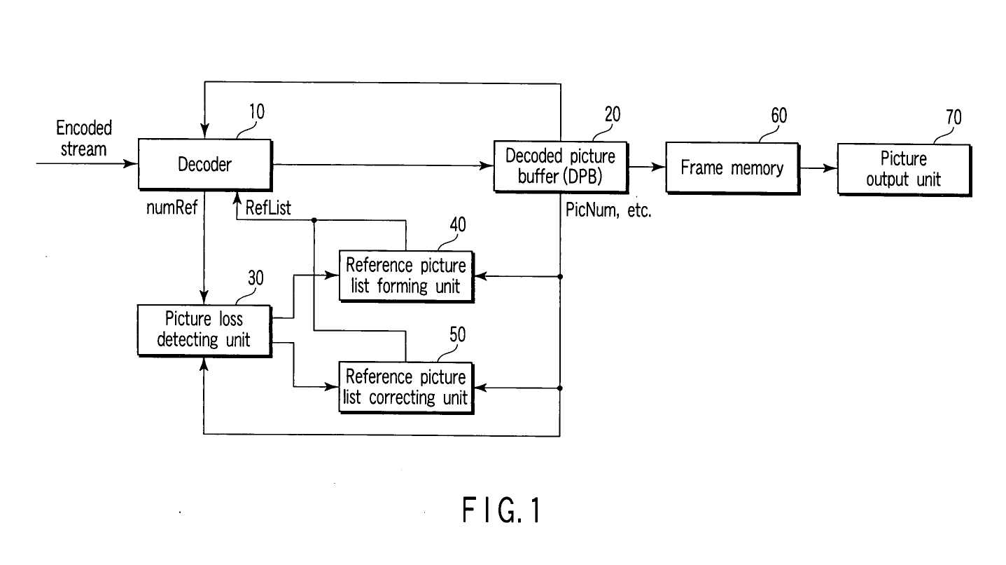

Embodiments of the present invention will be explained below with reference to the accompanying drawings. FIG. 1 shows a moving picture reproducing apparatus according to an embodiment of the present invention. The moving picture reproducing apparatus comprises a decoder 10, a decoded picture buffer (DPB) 20, a picture loss detecting unit 30, a reference picture list forming unit 40, a reference picture list correcting unit 50, a frame memory 60 and a picture output unit 70.

The decoder 10 extracts information on the number of reference frames numRef representing the number of reference frames used for decoding the encoded moving pictures contained in stream data, and notifies the information of the picture loss detecting unit 30. The number of reference frames numRef is included in PPS (Picture Parameter Set) or Slice Header in stream data.

The decoder 10 also reads from the decoded picture buffer 20 a decoded picture based on a reference picture list RefList notified by the reference picture list forming unit 40 or the reference picture list correcting unit 50 to be described later and obtains a decoded picture by decoding the stream data on the basis of the decoded picture. The decoded picture thus obtained is assigned a serial number PicNum based on reference picture numbers frame_num allocated to the respective frames in the encoding order.

The decoded picture buffer 20 stores a plurality of decoded pictures decoded by the decoder 10 together with the serial numbers PicNum. Then, when a decoded picture is input from the decoder 10 to the decoded picture buffer 20, the decoded picture buffer 20 outputs to the frame memory 60 the oldest decoded picture of the decoded pictures stored in the decoded picture buffer 20, on the basis of the serial numbers PicNum, and stores the input decoded picture instead of the oldest decoded picture. In the following descriptions, the decoded picture buffer 20 stores three decoded pictures.

The picture loss detecting unit 30 detects the number of lost frames lackRefPic generated in the stream data input in the decoder 10 on the basis of the number of reference frames numRef notified by the decoder 10 and the serial numbers PicNum of the decoded pictures stored in the decoded picture buffer 20. Then the picture loss detecting unit 30 gives the reference picture list forming unit 40 or the reference picture list correcting unit 50 an instruction to form the reference picture list RefList, on the basis of the detected number of dropout frames.

The reference picture list forming unit 40 forms the reference picture list RefList, on the basis of the number of reference frames numRef notified by the picture loss detecting unit 30 and the serial numbers PicNum of the decoded pictures stored in the decoded picture buffer 20, in accordance with the instruction from the picture loss detecting unit 30.

The reference picture list correcting unit 50 forms the reference picture list RefList, on the basis of the number of reference frames numRef and the number of lost frames lackRefPic notified by the picture loss detecting unit 30 and the serial numbers PicNum of the decoded pictures stored in the decoded picture buffer 20, in accordance with the instruction from the picture loss detecting unit 30.

The frame memory 60 temporarily stores the decoded pictures output from the decoded picture buffer 20. The picture output unit 70 reads the decoded pictures stored in the frame memory 60, in accordance with the serial numbers PicNum of the respective decoded pictures, and outputs the decoded pictures to a display unit (not shown), etc. of a subsequent stage.

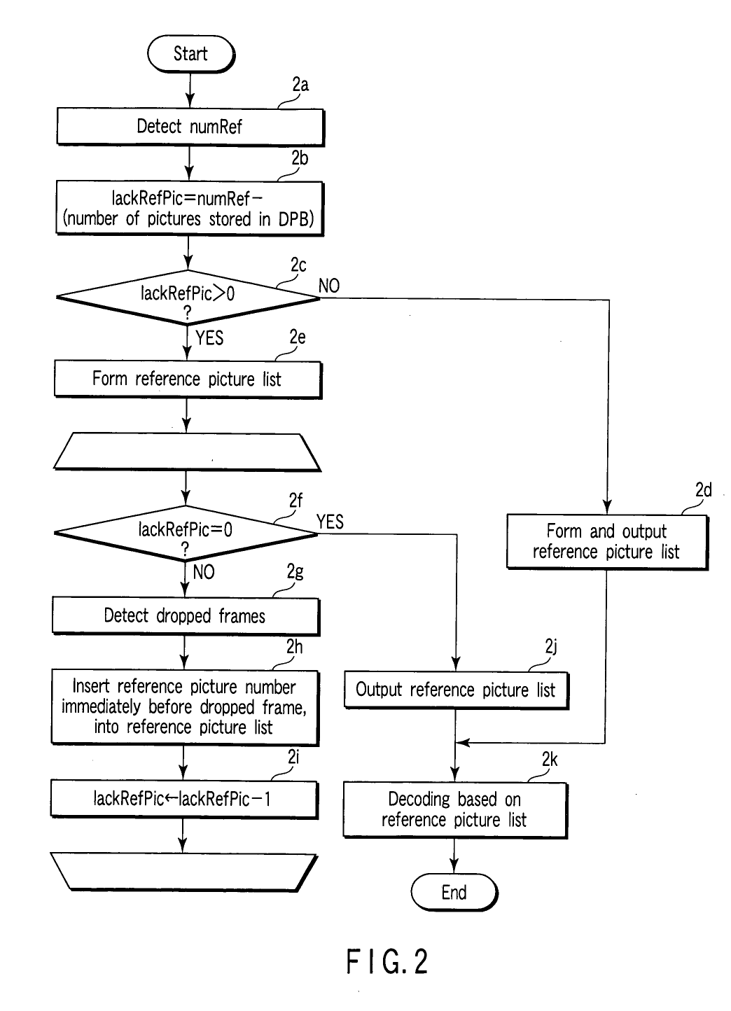

Next, operations of the moving picture reproducing apparatus having the above-described configuration are explained. The operations of the moving picture reproducing apparatus are shown in a flowchart of FIG. 2. The processing represented by the flowchart is repeated by unit of frames included in the stream data.

First, in step 2a, the decoder 10 extracts the information on the number of reference frames numRef representing the number of reference frames used for decoding from the stream data, and notifies the information of the picture loss detecting unit 30. The operation shifts to step 2b.

In step 2b, the picture loss detecting unit 30 subtracts the number of decoded pictures stored in the decoded picture buffer 20 from the number of reference frames numRef notified by the decoder 10 in step 2a. Then the picture loss detecting unit 30 sets the subtraction result as the number of dropout frames lackRefPic generated in the stream data input to the decoder 10. The operation shifts to step 2c.

In step 2c, the picture loss detecting unit 30 discriminates whether or not the number of lost frames lackRefPic obtained in step 2b is greater than 0. If the number of lost frames lackRefPic is greater than 0, i.e. if the lost frames are generated in the stream data, the picture lost detecting unit 30 gives the reference picture list correcting unit 50 an instruction to execute a loop in steps 2f to 2h. However, if the number of lost frames lackRefPic is equal to or smaller than 0, i.e. if the lost frames are not generated in the stream data, the picture loss detecting unit 30 gives the reference picture list forming unit 40 an instruction to execute the processing in step 2d.

In step 2d, the reference picture list forming unit 40 forms the reference picture list RefList as a list of the reference picture numbers frame_num of the decoded pictures which should be referred to at the decoding, on the basis of the number of reference frames numRef notified by the picture loss detecting unit 30 and the serial numbers PicNum of the decoded pictures stored in the decoded picture buffer 20, in accordance with the instruction from the picture loss detecting unit 30, and outputs the list to the decoder 10.

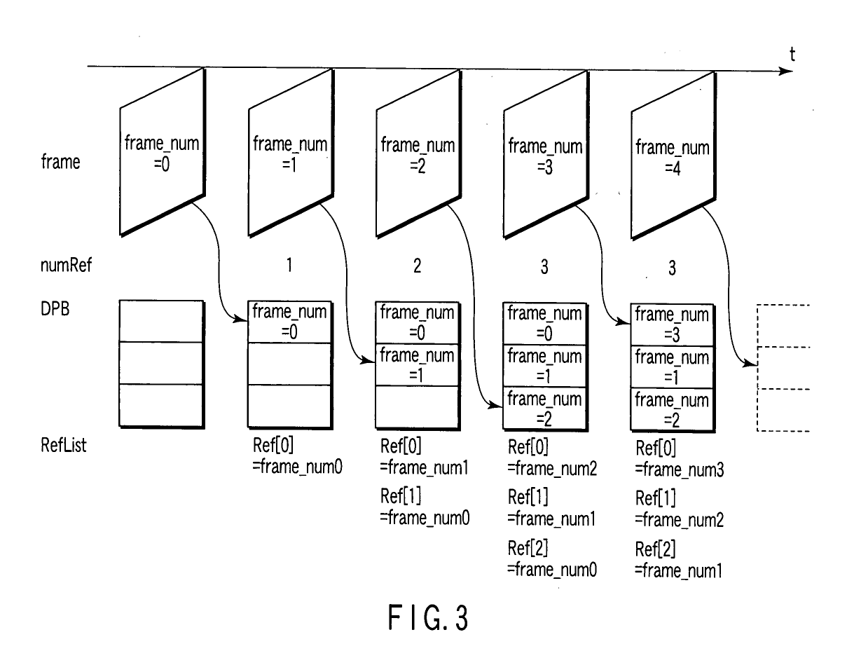

FIG. 3 shows a case where lost frames are not generated in the frames of reference picture numbers frame_num 0-4, of the frames included in the stream data. If the lost frames are not generated, the processing of step 2d is executed in each of the frames and the reference picture list forming unit 40 forms the reference picture list RefList for each of the frames.

For example, when the frame of reference picture number frame_num 3 is decoded, the decoded pictures of reference picture numbers frame_num 0, frame_num 1 and frame_num 2 and the serial numbers PicNum of the respective decoded pictures are stored in the decoded picture buffer 20.

At this time, since the number of reference frames numRef notified by the picture loss detecting unit 30 is “3”, the reference picture list forming unit 40 forms the reference picture list RefList as a list of the reference picture numbers frame_num so as to refer to the decoded pictures of three reference picture numbers frame_num 0, frame_num 1, and frame_num 2 in an order of the serial numbers PicNum corresponding to the respective reference picture numbers.

On the other hand, if the lost frames are generated in the stream data, step 2e is executed and then a loop processing in steps 2f to 2h is executed by the reference picture list correcting unit 50.

First, in step 2e, the reference picture list correcting unit 50 forms the reference picture list RefList as a list of the reference picture numbers frame_num so as to refer to the decoded pictures stored in the decoded picture buffer 20 in an order of the serial numbers PicNum corresponding to the respective decoded pictures. The operation shifts to step 2f.

In step 2f, the reference picture list correcting unit 50 discriminates whether or not the number of dropout frames lackRefPic is 0. If the number of lost frames lackRefPic is 0, the reference picture list correcting unit 50 discriminates that the formation of the reference picture list RefList is completed, and the operation shifts to step 2j. If the number of dropout frames lackRefPic is not 0, the operation shifts to step 2g.

In step 2g, the reference picture list correcting unit 50 refers to the serial numbers PicNum of the decoded pictures stored in the decoded picture buffer 20 and detects the reference picture numbers frame_num of the lost frames. The operation shifts to step 2h.

In step 2h, to compensate for the lost frames detected in step 2h in the reference picture list RefList, the reference picture list correcting unit 50 sets the reference picture numbers frame_num of the frames immediately before the lost frames, in the reference picture list RefList, instead of the reference picture numbers frame_num of the lost frames detected in step 2h. The operation shifts to step 2i.

In step 2i, the reference picture list correcting unit 50 subtracts 1 from the number of lost frames lackRefPic. The operation shifts to step 2f. After that, the loop processing of steps 2f to 2h is executed by the reference picture list correcting unit 50 and, in relation to all the lost frames, the reference picture numbers frame_num of the frames immediately before the lost frames, are set in the reference picture list RefList, instead of the reference picture numbers frame_num of the lost frames.

The frames used instead of the reference picture numbers frame_num of the lost frames may not be the frames immediately before the lost frames, but the frames including macro-blocks of high reference frequency. In addition, in a case where the frame immediately before the lost frames is subjected to the concealment processing since an error is included in the frame, a frame further immediately before the frame other than the frame subjected to the concealment processing is used. In other words, use of the frames may be limited so as to use a frame which is not subjected to the concealment processing.

In step 2j, the reference picture list correcting unit 50 outputs the reference picture list RefList generated by the loop processing in step 2e and steps 2f to 2h to the decoder 10. The operation shifts to step 2k.

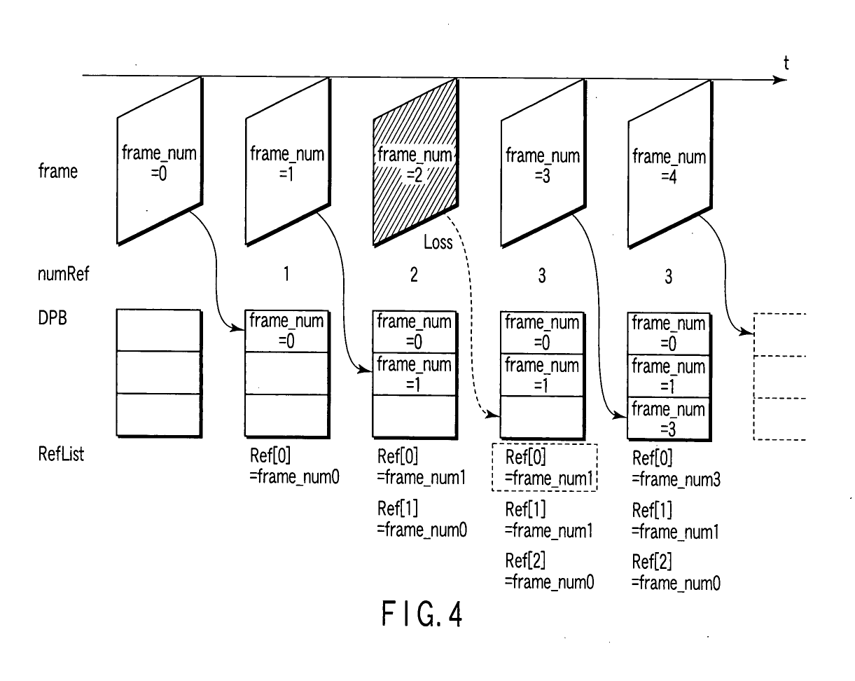

FIG. 4 shows a case where the frame of the reference picture number frame_num 2 is lost, in the frames of the reference picture numbers frame_num 0 to 4, of the frames included in the stream data. In this case, the frame of the reference picture number frame_num 2 is not decoded due to the picture loss, and the reference picture list forming unit 40 executes the processing in step 2d, for the frames of frame_num 0, 1 and 4 and forms the reference picture list RefList. This operation is the same as the processing described with reference to FIG. 3 and is not described here.

On the other hand, as for the frame of the reference picture number frame_num 3, the loop processing in step 2e and steps 2f to 2h is executed by the reference picture list correcting unit 50 to form the reference picture list RefList. In other words, the reference picture list correcting unit 50 forms the reference picture list RefList on the basis of the decoded pictures stored in the decoded picture buffer 20 in step 2e, and detects that the lost frame is the frame of the reference picture number frame_num 2 by referring to the serial numbers PicNum of the decoded pictures stored in the decoded picture buffer 20 in step 2g.

In step 2h, the reference picture list correcting unit 50 sets the reference picture number frame_num 1 immediately before the frame loss (frame_num 2) in the reference picture list RefList, instead of the lost frame (frame_num 2), to compensate for the lost frame (frame_num 2) in the reference picture list RefList. In step 2i, the reference picture list correcting unit 50 subtracts one from the number of lost frames lackRefPic. The operation shifts to step 2f.

In step 2f, the reference picture list correcting unit 50 discriminates that the formation of the reference picture list RefList is completed since the number of lost frames lackRefPic becomes zero. The operation shifts to step 2j. In step 2j, the reference picture list correcting unit 50 outputs the formed reference picture list RefList to the decoder 10. The operation shifts to step 2k.

In step 2k, the decoder 10 is notified of the reference picture list RefList from the reference picture list forming unit 40 or the reference picture list correcting unit 50 in step 2d or step 2j, reads the decoded pictures based on the reference picture list RefList from the decoded picture buffer 20, and obtains the decoded pictures by decoding the stream data on the basis of the read decoded pictures.

The decoded pictures thus obtained are temporarily stored in the decoded picture buffer 20, used for the decoding of subsequent frames as described above, as occasion requires, and output to a display unit of a subsequent stage, etc. via the frame memory 60 and the picture output unit 70.

In the moving picture reproducing apparatus having the above-described configuration, if the frame which should be referred to is lost when the stream data are decoded, the reference picture list RefList making an instruction to refer to the frame immediately before the lost frame, instead of the lost frame, is formed and the stream data are decoded on the basis of the reference picture list RefList.

Therefore, even if the number of reference frames on the encoder side does not match that on the decoder due to the influence such as the packet loss, etc., the controls of duplicating the decoded pictures stored in the decoded picture buffer 20, changing the order thereof, etc. do not need to be executed, the concealment processing of small processing load can be executed under control of the reference picture list RefList alone, and the influences to the reproduced pictures can be reduced to a minimum.

In other words, even in a case where bit errors are included in the number of reference frames numRef in the stream data, the concealment is executed under control of the reference picture list RefList alone. After that, the stream data can be decoded without propagating the influence of the errors to the decoded picture buffer 20.

In addition, when the reference picture list RefList compensating for the lost frame is formed, the list compensates for the lost frame with the frame immediately before the lost frame. Therefore, it is also possible to normally refer to the frame immediately before the lost frame.

The present invention is not limited to the embodiments described above but the constituent elements of the invention can be modified in various manners within the scope of this invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A moving picture reproducing apparatus, decoding stream data including picture data in which a moving picture is encoded for each frame, the apparatus comprising:
memory means for storing the decoded picture data;
decoding means for referring to picture data represented by a reference list, of the picture data stored in the memory means, and decoding the picture data included in the stream data;
reference frame number detecting means for detecting number of reference frames included in the stream data;
picture loss detecting means for detecting the lost picture data based on the detected reference frame number and the decoded picture data; and
reference list forming means for forming the reference list in accordance with the number of reference frames detected by the reference frame number detecting means, wherein if the picture loss detecting means detects the lost picture data, the reference list forming means forms the reference list indicating referring to picture data decoded prior to the lost picture data, instead of the lost picture data.

2. The apparatus according to claim 1, wherein if the picture loss detecting means detects the lost picture data, the reference list forming means forms a reference list indicating referring to picture data decoded immediately before the lost picture data, instead of the lost picture data.

3. The apparatus according to claim 1, wherein the picture loss detecting means detects the lost picture data, from a difference between the number of reference frames detected by the reference frame number detecting means and number of the picture data stored in the memory means.

4. The apparatus according to claim 1, wherein the picture loss detecting means detects the lost picture data from continuity of frame numbers assigned to the picture data included in the stream data.

5. A moving picture reproducing apparatus, decoding stream data including picture data in which a moving picture is encoded for each frame, the apparatus comprising:
memory means for storing the decoded frames;
decoding means for referring to frames represented by a reference list, of the frames stored in the memory means, and decoding the picture data included in the stream data;
reference frame number detecting means for detecting number of reference frames included in the stream data;
picture loss detecting means for detecting the lost frame based on the detected reference frame number and the decoded picture data; and
reference list forming means for generating the reference list in accordance with the number of reference frames detected by the reference frame number detecting means, wherein if the picture loss detecting means detects the lost frame, the reference list generating means forms the reference list indicating referring to frame decoded prior to the lost frame, instead of the lost frame.

6. The apparatus according to claim 5, wherein if the picture loss detecting means detects the lost frame, the reference list generating means generates the reference list indicating referring to frame decoded immediately before the lost frame, instead of the lost frame.

7. The apparatus according to claim 5, wherein the picture loss detecting means detects the lost frame, based on a difference between the number of reference frames detected by the reference frame number detecting means and number of the frames stored in the memory means.

8. The apparatus according to claim 5, wherein the picture loss detecting means detects the lost frame based on continuity of frame numbers assigned to the frame included in the stream data.

9. A moving picture decoding apparatus, decoding stream data including picture data in which a moving picture is encoded for each frame, the apparatus comprising:
memory means for storing the decoded frames contained in the stream data;
decoding means for referring to frames represented by a reference list, of the frames stored in the memory means, and decoding the picture data included in the stream data;
reference frame number detecting means for detecting number of reference frames included in the stream data;
picture loss detecting means for detecting the lost frame based on the detected reference frame number and the decoded picture data; and
reference list forming means for generating the reference list in accordance with the number of reference frames detected by the reference frame number detecting means, wherein if the picture loss detecting means detects the lost frame, the reference list generating means forms the reference list indicating referring to frame decoded prior to the lost frame, instead of the lost frame.

10. The apparatus according to claim 9, wherein if the picture loss detecting means detects the lost frame, the reference list generating means generates a reference list indicating referring to a frame decoded immediately before the lost frame, instead of the lost frame.

11. The apparatus according to claim 9, wherein the picture loss detecting means detects the lost frame, based on a difference between the number of reference frames detected by the reference frame number detecting means and number of the frames stored in the memory means.

12. The apparatus according to claim 9, wherein the picture loss detecting means detects the lost frame based on continuity of frame numbers assigned to the frame included in the stream data.
